(19) United States
(12) Patent Application Publication
(10) Pub. No.: US 2010/0009199 A1
(43) Pub. Date: Jan. 14, 2010

(54) METHOD FOR COLOURING SUBSTRATES CONTAINING CELLULOSE

(75) Inventors: Ingo Klopp, Weisenheim (DE); Hans Kraus, Dannstadt-Schauernheim (DE); Gero Nordmann, Heidelberg (DE); Holger Schoepke, Neckargemuend (DE); Dominik Winter, Ludwigshafen (DE); Knoben Heidrun, Sinzheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF Aktiengesellschaf, Ludwigshafen (DE)

(21) Appl. No.: 11/722,286

(22) PCT Filed: Dec. 16, 2005
(86) PCT No.: PCT/EP05/13550

§ 371 Date: Jun. 20, 2007

(30) Foreign Application Priority Data
Dec. 20, 2004 (DE) 10 2004 062 437.2

(51) Int. Cl. B32B 27/10; C08L 1/02; C09D 139/00; C09D 133/02

(52) U.S. Cl. 428/425.1; 524/35; 524/13; 428/514; 524/555; 524/556

(57) ABSTRACT

The present invention relates to a process for coloring cellulosic substrates, which comprises substrates to be colored, or precursors thereof, being contacted with at least one treated pigment in particulate form that is at least partially enveloped by at least one cationic copolymer.

The present invention relates to a process for coloring cellulosic substrates, which comprises substrates to be colored, or precursors thereof, being contacted with at least one treated pigment in particulate form that is at least partially enveloped by at least one cationic copolymer.

Specifically, the present invention relates to a process for coloring cellulosic substrates wherein substrates to be colored, or precursors thereof, are contacted with at least one treated pigment in particulate form that has been prepared according to a process comprising the steps of:
a) dispersing at least one pigment in particulate form with at least one nonionic surface-active material,
b) mixing the thus obtainable dispersion of pigment in particulate form and nonionic surface-active material with aqueous medium,
c) addition polymerizing at least one first monomer or addition copolymerization of a first mixture of comonomers in the presence of a mixture according to b) to form water-insoluble polymer or copolymer on the surface of pigment in particulate form,
d) adding at least one second monomer or a second mixture of comonomers and addition polymerization or copolymerization.

Colorant preparations which are to be used in state of the art processes for coloration of cellulosic substrates have to meet demanding requirements. Colored substrates shall exhibit colors of high brightness and the coloration shall be durable, i.e., have high fastnesses such as rub fastness and light fastness for example. Furthermore, in the case of wood as cellulosic substrate, colorants should penetrate into the wood in certain proportions and should not merely remain on the surface. Once incorporated, the colorants should no longer migrate.

Pure pigments which by definition are insoluble or are substantially insoluble in their application medium frequently stay on the surface of wood to be colored.

There have been attempts to treat pigments by enveloping them with a polymer.

U.S. Pat. No. 3,133,893 discloses enveloping pigments (which have been treated with a surface-active agent) with a polyacrylonitrile which has polymerized in the presence of the pigment. The pigments thus enveloped can be incorporated into fibers, but are not very useful for coloration of cellulosic substrates.

U.S. Pat. No. 4,608,401 discloses a method of encapsulating pigments for latex paints which comprises the steps of dispersing pigment particles in water using water-insoluble monomers and a detergent under zero shear conditions and then subjecting the dispersion to the conditions of an emulsion polymerization. The pigments thus enveloped are not very useful for coloration of cellulosic substrates.

U.S. Pat. No. 4,680,200 discloses a method of encapsulating nonpretreated pigments which comprises dispersing pigment particles in water using styrene and the Polywet KX-3 oligomer from Uniroyal and then subjecting the dispersion to the conditions of an emulsion polymerization. However, the results of coloring cellulosic substrates are unsatisfactory.

The present invention thus has for its object to provide a process for coloration of cellulosic substrates which avoids prior art disadvantages and yields particularly well-dyed or through-dyed cellulosic substrates. The present invention further has for its object to provide dyed cellulosic substrates.

We have found that this object is achieved by the process defined at the beginning.

Coloration is hereinbelow to be understood as referring to processes for conferring color which not only effect a superficial conferral of color but also cause at least pro rata, at a certain depth of the substrate in question, a color conferral which can be as intensive as or slightly less intensive than the color conferred at the surface. Processes for printing are hereinbelow not comprised.

Cellulosic substrates are hereinbelow to be understood as meaning woody and so-called wood-free papers boards cards also wood in any desired dimensions, for example cut wood products such as boards, bars, blocks, also wood wool, woody composites, cut wood products, plywood, particleboard, medium density fiber (MDF) board, oriented strand board (OSB), materials based on lignified annuals, strawboard and fiber materials such as for example flax, linen, hemp, jute, cotton, bamboo fibers, fibers from paper mulberry tree or groundwood pulp. Cellulosic substrates for the purposes of the present invention may be for example sheetlike or molded.

Precursors for the purposes of the present invention are in particular paper precursors, for example bleached and unbleached pulps and groundwoods, paper stock and wood chips.

The present invention comprises substrates to be colored, or precursors thereof, being contacted with at least one treated pigment in particulate form that is at least partially enveloped by at least one cationic copolymer.

The process of the present invention is carried out by starting specifically from treated pigment. Treated pigment refers to pigment which is at least partially enveloped with at least one cationic copolymer. Treated pigment can also be completely enveloped with cationic copolymer. Treated pigment for the purposes of the present invention is preferably not less than 10% to 99% enveloped with cationic copolymer, preferably to an extent in the range from 40% to 70%, the percentages being determinable by microscopic methods for example.

Partially enveloped may in one embodiment of the present invention be understood as meaning that a certain percentage of pigment particles is enveloped by cationic copolymer and the rest of the pigment particles is not enveloped by cationic copolymer.

In another embodiment of the present invention, partially enveloped may be understood as meaning that all pigmentary particles are partially enveloped.

The envelopment with cationic copolymer is typically so thin that even completely enveloped pigmentary particles appear to have color.

Pigment partially enveloped with cationic copolymer is preferably produced by synthesizing the cationic copolymer in question in the presence of pigment. In one preferred embodiment of the present invention, cationic copolymer is synthesized in the presence of pigment by an emulsion polymerization process, most preferably by an at least two-stage emulsion polymerization process in which the composition of comonomers is changed at least once, for example by changing the comonomer feed.

Cationic copolymers for the purposes of the present invention are copolymers of ethylenically unsaturated compounds which are free-radically polymerizable, at least one of which bears a protonatable groups, for example nitrogen atoms having a free pair of electrons, or cationic groups such as for example quaternary nitrogen atoms incorporated in the polymer chain.

In one embodiment of the present invention, cationic copolymers are at least partially protonated under acidic conditions, for example at pH values of 6 or less. Cationic copolymers may be for example such copolymers as bear free amino groups, for example NH₂ groups, NH(C₁-C₄-alkyl) groups or N(C₁-C₄-alkyl)₂ groups.

In one embodiment of the present invention, cationic copolymers are copolymers comprising interpolymerized units of one or more amides of at least one ethylenically unsaturated carboxylic acid, for example (meth)acrylamide.

In one embodiment of the present invention, cationic copolymers have a molecular weight M_{w} in the range from 10 000 to 10 000 000 g/mol and preferably in the range from 100 000 to 5 000 000 g/mol.

In one embodiment of the present invention, cationic copolymers are copolymers constructed of at least one nonionic comonomer, for example a vinylaromatic compound such as for example styrene or at least one C₁-C₂₀-alkyl ester of at least one ethylenically unsaturated carboxylic acid, and at least one comonomer having at least one protonatable or quaternized nitrogen atom per molecule.

Cationic copolymers for the purposes of the present invention may also comprise one or more anionic comonomers such as for example (meth)acrylic acid or crotonic acid in interpolymerized form. When cationic copolymers also comprise at least one anionic monomer in interpolymerized form, the molar fraction of cationic comonomers will always be higher than the molar fraction of anionic comonomers, for example by 0.5 mol %, based on total cationic copolymer, preferably not less than 1 mol % and more preferably in the range from 1.5 to 20 mol %.

Cationic copolymer is preferably synthetic cationic copolymer.

The process of the present invention is further started from pigments in preferably particulate form. Pigments for the purposes of the present invention are substantially insoluble, finely divided, organic or inorganic colorants as per the definition in German standard specification DIN 55944.

Pigments can be selected from inorganic and preferably organic pigments,

Illustratively selected inorganic pigments are

zinc oxide, zinc sulfide, lithopones, lead white, lead sulfate, chalk, titanium dioxide, calcium carbonate, kaolin; iron oxide yellow, cadmium yellow, nickel titanium yellow, chromium titanium yellow, chrome yellow, lead chromate, bismuth vanadate, Naples yellow or zinc yellow,
ultramarine blue, cobalt blue, manganese blue, iron blue,
ultramarine green, cobalt green, chrome oxide (chrome oxide green);
ultramarine violet, cobalt violet, manganese violet;
ultramarine red, molybdate red, chromium red, cadmium red;
iron oxide brown, chromium iron brown, zinc iron brown, manganese titanium brown;
iron oxide black, iron manganese black, spinel black, carbon black;
orange spinels and corundums, cadmium orange, chromium orange, lead molybdate;
aluminum or Cu/Zn alloy.

Preference is given to carbon black, carbon black, calcium carbonate, kaolin, iron oxide pigments such as for example iron oxide yellow, iron oxide brown and iron oxide black, zinc oxide and titanium dioxide.

Suitable carbon blacks are in particular those produced by the gas black process, the flame black process or the furnace black process.

The BET surface area of carbon black used according to the present invention can be for example in the range from 20 to 2000 m²/g, determined according to DIN 66131/2 or ISO 4652.

Carbon black used according to the present invention can be surface modified, for example by oxidation. Carbon black used according to the present invention can comprise acidic and/or basic groups, for example carboxyl groups, lactol groups, phenol groups, quinone groups, basic oxides having for example pyronelike structures.

Illustratively selected organic pigments, which hereinbelow also include vat dyes, are

monoazo pigments, such as for example C.I. Pigment Brown 25; C.I. Pigment Orange 5, 13, 36 and 67; C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251; C.I. Pigment Yellow 1, 3, 73, 74, 65, 97, 151 and 183;
disazo pigments, such as for example C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188;
anthanthrone pigments, such as for example C.I. Pigment Red 168 and C.I. Vat Orange 3;
anthraquinone pigments, such as for example C.I. Pigment Yellow 147 and 177; C.I. Pigment Violet 31;
anthrapyrimidine pigments, such as for example C.I. Pigment Yellow 108, C.I. Vat Yellow 20;
quinacridone pigments, such as for example C.I. Pigment Red 122, 202 and 206; C.I. Pigment Violet 19,
quinophthalone pigments, such as for example C.I. Pigment Yellow 138;
diketopyrrolopyrrole pigments, such as for example C.I. Pigment Orange 71, 73 and 81; C.I. Pigment Red 254, 255, 264, 270 and 272;
dioxazine pigments, such as for example C.I. Pigment Violet 23 and 37;
flavanthrone pigments, such as for example C.I. Pigment Yellow 24, C.I. Vat Yellow 1;
indanthrone pigments, such as for example C.I. Pigment Blue 60 and 64, C.I. Vat Blue 4 and 6;
isoindoline pigments, such as for example C.I. Pigment Orange 69; C.I. Pigment Red 260; C.I. Pigment Yellow 139 and 185;
isoindolinone pigments, such as for example C.I. Pigment Orange 61;

### C.I. Pigment Red 257 and 260; C.I. Pigment Yellow 109, 110, 173 and 185;

isoviolanthrone pigments, such as for example C.I. Pigment Violet 31 and C.I. Vat Violet 1;
metal complex pigments, such as for example C.I. Pigment Yellow 117, 150 and 153;

### C.I. Pigment Green 8;

perinone pigments, such as for example C.I. Pigment Orange 43, C.I. Vat Orange 7, C.I. Pigment Red 194, C.I. Vat Red 15;
perylene pigments, such as for example C.I. Pigment Black 31 and 32; C.I. Pigment Red 123, 149, 178, 179, C.I. Vat Red 23, 190, 29 and 224; C.I. Pigment Violet 29;
phthalocyanine pigments, such as for example C.I. Pigment Blue 15, 15:1, 15:2, 15:3, 15:4, 15:6 and 16; C.I. Pigment Green 7 and 36;
pyranthrone pigments, such as for example C.I. Pigment Orange 51;

### C.I. Pigment Red 216 and C.I. Vat Orange 4;

thioindigo pigments, such as for example C.I. Pigment Red 88 and 181, C.I. Vat Red 1;

### C.I. Pigment Violet 38 and C.I. Vat Violet 3;

triarylcarbonium pigments, such as for example C.I. Pigment Blue 1, 61 and 62;
C.I. Pigment Green 1; C.I. Pigment Red 81, 81:1 and 169; C.I. Pigment Violet 1, 2, 3 and 27; C.I. Pigment Black 1 (aniline black);
C.I. Pigment Yellow 101 (aldazine yellow);

### C.I. Pigment Brown 22.

Examples of particularly preferred organic pigments are: C.I. Pigment Yellow 138, C.I. Pigment Red 122, C.I. Pigment Violet 19, C.I. Pigment Blue 15:3 and 15:4, C.I. Pigment Black 7, C.I. Pigment Orange 5, 38 and 43 and C.I. Pigment Green 7.

According to the present invention, it is also possible to start with mixtures of two or more different pigments.

The starting pigments are in particulate form, i.e. in the form of particles. The staring pigments are for example crude pigments, i.e., untreated as-synthesized pigments. The particles may be regular or irregular in shape in that, for example, the particles may have a spherical or substantially spherical shape or a needle (acicular) shape. To this end, step (a) can be carried out such that a wet comminution takes place.

One embodiment of the present invention starts with preground pigment.

One embodiment of the present invention starts with preground pigment coated with at least one pigment derivative, for example a pigmentsulfonic acid, a pigmentamidosulfonic acid or a methyleneamine derivative of a pigment.

The pigment or pigments in particulate form is or are dispersed in step a) with at least one nonionic surface-active material.

Examples of suitable nonionic surface-active materials are for example ethoxylated mono-, di- and trialkylphenols (degree of ethoxylation: 3 to 50, alkyl radical: C₃-C₁₂) and also ethoxylated fatty alcohols (EO degree: 3 to 80; alkyl radical: C₈-C₃₆). Examples thereof are the Lutensol® brands from BASF AG or the Triton® brands from Union Carbide. Particular preference is given to ethoxylated linear fatty alcohols of the general formula III

n-CₓH₂ₓ₊₁—O(CH₂CH₂O)_{y}—H, III

where each x is an integer from 10 to 24 and preferably from 12 to 20. The y variable is preferably an integer in the range from 5 to 50 and more preferably from 8 to 40.

Ethoxylated linear fatty alcohols of the general formula III are typically present as a mixture of various ethoxylated fatty alcohols having different degrees of ethoxylation. y represents the number average mean in the context of the present invention.

The dispersing of pigment in particulate form and at least one nonionic surface-active material is effected in apparatus which is suitable for dispersing, preferably in mills such as for example ball mills or stirred media mills. A Drais Super low DCP SF 12 ball mill is particularly suitable.

An example of a suitable dispersing time is in the range from ½ hour to 48 hours but longer times are conceivable. The dispersing time is preferably in the range from 5 to 24 hours.

Dispersing pressure and temperature conditions are generally not critical in that, for example, atmospheric pressure has been found to be suitable. As for temperatures, temperatures in the range from 10° C. to 100° C. for example have been found to be suitable.

The mixing ratio of pigment to nonionic surface-active material can be chosen within wide limits and may be for example in the range from 10:1 to 2:1.

Water can be added while step a) is carried out. Similarly, customary nonionic grinding auxiliaries may be added.

The pigment number average diameter after step a) is typically in the range from 10 nm to 5 μm and preferably in the range from 50 nm to 3 μm.

When pigment is carbon black, the number average diameter of the primary particles can be for example in the range from 5 to 200 nm.

Commonly employed methods are suitable for determining the average diameter, an example being electron microscopy.

Step b) comprises mixing the dispersion of pigment in particulate form and nonionic surface-active material that is obtainable according to step a) with aqueous medium. Any desired mixing apparatus can be used, an example being stirred tanks or stirred flasks.

Aqueous media for the purposes of the present invention are liquid media which comprise water as an important component, for example not less than 40% by weight and preferably not less than 55% by weight.

The step b) weight ratio of the dispersion of pigment in particulate form and nonionic surface-active material to aqueous medium is generally in the range from 1:1.5 to 1:15 and preferably in the range from 1:2.5 to 1:9.

Step b) pressure and temperature conditions are generally not critical in that, for example, temperatures in the range from 5 to 100° C. are suitable, preferably from 20 to 85° C. and pressures in the range from atmospheric pressure to 10 bar.

The mixing of step b) results in the obtainment of a mixture.

Step c) comprises addition polymerizing at least one first monomer or addition copolymerization of a first mixture of comonomer in the presence of a mixture obtain able according to b) to form water-insoluble polymer or copolymer, respectively, on the surface of pigment in particulate form.

Step c) is carried out by adding at least one monomer or at least one mixture of comonomers to a mixture obtainable according to b). The addition can be effected for example in one portion, in plural portions or else continuously. To copolymerize at least different monomers with each or one another, a first comonomer may be added and thereafter the second and any further comonomers. In another embodiment, all the comonomers are added in one portion.

Monomers and comonomers may be added neat or in aqueous dispersion.

The monomers and comonomers chosen for step c) are such monomers and comonomers as are sparingly soluble in water. “Sparingly water-soluble monomers and comonomers” is to be understood as meaning such monomers and comonomers as have a solubility in water of 1×10⁻¹ mol/l or less at 50° C.

Preferred examples of monomers and comonomers in step c) are vinylaromatic compounds and sparingly water-soluble α,β-unsaturated carboxylic acid derivatives.

As vinylaromatic compound there is preferably chosen at least one compound of the general formula IV

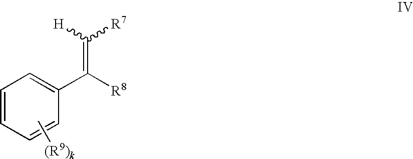

where R⁷ and R⁸ are each independently hydrogen, methyl or ethyl, R⁹ is methyl or ethyl and k is an integer from 0 to 2; most preferably, R⁷ and R⁸ are each hydrogen and most preferably k=0.

As sparingly water-soluble α,β-unsaturated carboxylic acid derivative there is preferably chosen a compound of the general formula I

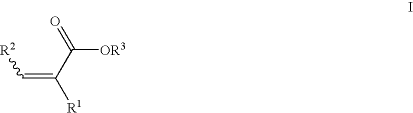

where
R¹ is selected from
   branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or hydrogen,
   most preferably hydrogen and methyl;
R² is selected from
   branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or most preferably hydrogen.

R³ is selected from branched or unbranched C₄-C₁₀-alkyl, such as n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; most particularly n-butyl and 2-ethylhexyl.

In one embodiment of the present invention, the ratio of pigment to amount of monomer or comonomers in step c) is in the range from 3:1 to 1:2 and preferably in the range from 2:1 to 1:1.5.

Step c) may be carried out using mixtures of the aforementioned monomers. For example, mixtures of styrene and n-butyl acrylate are very useful, their mixing ratio being freely choosable.

Polymerizing is preferably carried out under the conditions of an emulsion polymerization. Most preferably, starved conditions are employed in that little or preferably no wetting agent is added. There are thus no detectable fractions obtained of stabilized droplets of first monomer or of first mixture of comonomers, and the wetting agent fraction serves to wet the pigment surface and to transport first monomer, or first mixture of comonomers, through the continuous aqueous phase. Useful wetting agents include for example organic sulfur compounds, for example alkyl sulfates, alkyl sulfonates, alkylaryl sulfonates, alkyl ether sulfates, alkylaryl ether sulfates, sulfosuccinates such as sulfosuccinic monoesters and sulfosuccinic diesters; also organic phosphorus compounds such as alkyl ether phosphates for example.

The polymerization will typically be carried out using at least one initiator. At least one initiator can be a peroxide. Examples of suitable peroxides are alkali metal peroxodisulfates, for example sodium peroxodisulfate, ammonium peroxodisulfate, hydrogen peroxide, organic peroxides such as diacetyl peroxide, di-tert-butyl peroxide, diamyl peroxide, dioctanoyl peroxide, didecanoyl peroxide, dilauroyl peroxide, dibenzoyl peroxide, bis(o-toluoyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate. It is also possible to use azo compounds such as for example azobisisobutyronitrile, azobis(2-amidopropane) dihydrochloride and 2,2′-azobis(2-methylbutyronitrile) and 2,2-azobis(2-amidinopropane) dihydrochloride.

Redox initiators are likewise suitable, composed for example of peroxides and an oxidizable sulfur compound. Very particular preference is given to systems formed from acetone bisulfite and organic peroxide such as tert-C₄H₉—OOH, Na₂S₂O₅ (sodium disulfite) and organic peroxide such as tert-C₄H₉—OOH or of a combination of alkali metal salt of HO—CH₂SO₂H and organic peroxide such as tert-C₄H₉—OOH. Similarly, systems such as for example ascorbic acid/H₂O₂ are particularly preferred.

The polymerization temperature may be chosen in the range from 20 to 100° C. and preferably in the range from 50 to 85° C. The temperature chosen is dependent on the decomposition characteristics of the initiator used.

Pressure conditions are generally not critical, pressures in the range from atmospheric pressure to 10 bar being suitable for example.

A suitable time for step c) is for example in the range from 1 to 30 minutes, preferably in the range from 2 to 20 minutes and more preferably in the range from 3 to 15 minutes.

It will be appreciated that further substances can be added to the reaction mixture that are customary in emulsion polymerization, for example glycols, polyethylene glycols, protective colloids, buffers/pH regulators, molecular weight regulators and chain transfer inhibitors.

Step c) provides polymer- or copolymer-enveloped pigment in particulate form, the pigment being obtained in the form of isolated particles. No measurable or only extremely small fractions of agglomerates are observed, for example less than 2% by weight and preferably less than 0.2% by weight.

The polymer or copolymer formed in step c) at the surface of the pigment in particulate form is water-insoluble.

A further step may be carried out whereby the dispersed polymer- or copolymer-enveloped pigment particles obtainable according to c) are isolated by purifying operations for example filtering, decanting or washing, and redispersed for practicing step d). Preferably, however, the mixed polymer- or copolymer-enveloped pigment particles obtainable according to c) are further processed in situ.

Step d) consists in adding at least one second monomer, or a second mixture of comonomers, to the dispersion from step c) or to the worked-up and redispersed enveloped pigment particles and addition polymerizing or copolymerizing. The second monomer or at least one comonomer of the second mixture of comonomers is cationic.

The reference in the context of the present invention to a second mixture of comonomers in step d) also applies when one monomer was used in step c) and a mixture of two comonomers is added in step d). Similarly, the reference in the context of the present invention to a second monomer in step d) is to be understood as also comprehending the case when a mixture of comonomers was used in step c) and one monomer is added in step d).

When it is desired to add a second mixture of comonomers, at least one comonomer other than the monomer or the comonomers of step c) is added.

One embodiment of the present invention utilizes a vinylaromatic monomer in step c) and at least one monomer or comonomer capable of swelling polymer or copolymer of step c) in step d). Swelling is to be understood as meaning that, under normal conditions, at least 5% by weight of monomer or comonomer can be physically incorporated in the polymer or copolymer of step c).

It is very particularly preferred to add at least one comonomer of the general formula II

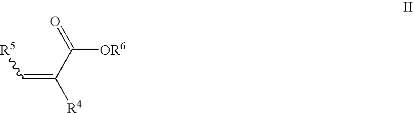

where
R⁴ is selected from
   branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or hydrogen;
      most preferably hydrogen and methyl;
R⁵ is selected from
   branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or most preferably hydrogen;
R⁶ is selected from branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl.

To add a mixture of comonomers in step d), it will be sufficient for at least one comonomer to differ from the monomer or comonomer of step c). For instance, styrene may be used in step c) and a mixture of methacrylamide and styrene in step d).

In one embodiment of the present invention, the weight ratio of second monomer or second mixture of comonomers from step d) to pigment from step a) is in the range from 0.1:1 to 10:1, preferably in the range from 0.5:1 to 7:1 and more preferably in the range from 2:1 to 5:1.

Overall, the amount of monomer or comonomer for steps c) and d) is chosen so that the ratio of polymer or copolymer to pigment is in the range from 1:2 to 5:1 and preferably in the range from 2:1 to 4:1.

The polymerizing or copolymerizing of step d) is preferably carried out under the conditions of an emulsion polymerization. Typically, at least one initiator is used, and the initiator or initiators can be chosen from those mentioned above.

It is possible to use at least one emulsifier, which may be cationic or nonionic.

Suitable nonionic emulsifiers are for example ethoxylated mono-, di- and tri-alkylphenols (degree of ethoxylation: 3-50, alkyl radical: C₄-C₁₂) and also ethoxylated fatty alcohols (degree of ethoxylation: 3-80; alkyl radical: C₈-C₃₆). Examples are the Lutensol® brands from BASF Aktiengeseilschaft and the Triton® brands from Union Carbide.

Suitable cationic emulsifiers are in general C₆-C₁₈-alkyl-, -aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. By way of example there may be mentioned dodecylammonium acetate or the corresponding hydrochloride, the chlorides or acetates of the various 2-(N,N,N-trimethylammonium)-ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the gemini surfactant N,N′-(lauryldimethyl)ethylenediamine dibromide. Numerous further examples are to be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

In one embodiment of the present invention, the amount of emulsifier is chosen so that the mass ratio between the second monomer or the second mixture of comonomers on the one hand and the emulsifier on the other is more than 1, preferably more than 10 and more preferably more than 15.

The order in which the reactants of step d) are added is in itself not critical.

In one embodiment of the present invention, the initiator is added when an emulsion having a milky appearance has been produced by stirring for example.

The polymerization temperature may be chosen in the range from 20 to 100° C. and preferably in the range from 50 to 85° C. The temperature chosen is dependent on the decomposition characteristics of the initiator used.

Pressure conditions are generally not critical, pressures in the range from atmospheric pressure to 10 bar being suitable for example.

As duration for the polymerization or copolymerization in step d) it is possible to choose a time in the range from 30 minutes to 12 hours, preference being given to the range from 2 to 3 hours.

In one embodiment of the present invention, step d) may add as a comonomer up to 20% by weight and preferably from 2 to 10% by weight based on monomers or comonomers of step d) of at least one compound of the general formula V a to V b

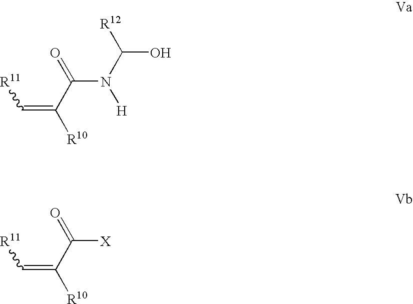

where
R¹⁰ is selected from
   branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or hydrogen;
      most preferably hydrogen and methyl;
R¹¹ is selected from
   branched or unbranched C₁-C₁₀-alkyl such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or most preferably hydrogen;
R¹² is selected from branched or unbranched C₁-C₁₀-alkyl such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
   or most preferably hydrogen;
X is selected from
   hydrogen,
   glycidyl

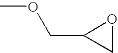

groups having tertiary amino groups, for example NH(CH₂)_{b}—N(CH₃)₂, where b is an integer from 2 to 6,
enolizable groups having 1 to 20 carbon atoms, for example acetoacetyl

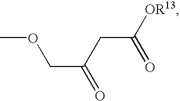

where
R¹³ is selected from branched or unbranched C₁-C₁₀-alkyl such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; More preferably C₁-C₄-alkyl such as methyl, ethyl, n-propyl, iso-propyl, n-butyl, iso-butyl, sec-butyl and tert-butyl.

Most preferably, in the formula V a or V b, R¹⁰ is selected from hydrogen and methyl and R¹¹ and R¹² are each hydrogen.

In a further embodiment of the present invention, step d) may be carried out using as comonomers: from 1% to 20%, preferably up to 5% by weight each of (meth)acrylonitrile, (meth)acrylamide, ureido (meth)acrylate, 2-hydroxyethyl (meth)acrylate, 2-(N,N-dimethyliamino)ethyl(meth)acrylate, 3-hydroxypropyl (meth)acrylate, 3-(N,N-dimethylamino)propyl(meth)acrylate, acrylamidopropane-sulfonic acid, branched or unbranched alkali metal salt and in more sodium salt of vinylsulfonic acid.

In one embodiment of the present invention, the second mixture of comonomers is chosen so that it comprises from 0.1% to 3% by weight, based on the amount of pigment in particulate form, of one or more unsaturated carboxylic acids of the formula VI

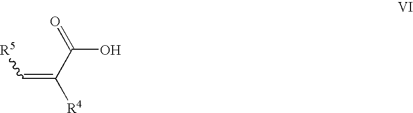

where the symbols are each as defined above.

One embodiment of the present invention comprises choosing the second monomer, or the second mixture of comonomers, such that step d) produces a polymer or copolymer having a glass transition temperature T_{g} of −30° C.

One preferred embodiment of the present invention utilizes a treated pigment in admixture with polymer or copolymer derived from monomers or mixtures of comonomers from step d). The polymer or copolymer derived from monomers or mixtures of comonomers from step d) respectively is preferably obtained in the form of spherical particles. The particles thus characterized will hereinafter also be referred to as pigment-free polymeric particles.

In one preferred embodiment, the weight ratio of (A) to pigment-free polymeric particles is in the range from 10:0.1 to 10:20 and preferably in the range from 10:0.5 to 10:4.

In one preferred embodiment, the average radii r of pigment-free polymeric particles are smaller than the average radii r(A), each based on the number average. The radii ratio

$$\frac{r ( A )}{r ( pigment \text{-} free polymeric particles )}$$

may be for example in the range from 1.2 to 10 and preferably in the range from 1.5 to 5.

The present invention's process for coloring cellulosic substrates can be carried out according to methods known per se. When, for example, paper, board or card is to be colored, the process of the present invention can be carried out by contacting a nonaqueous or preferably aqueous formulation comprising at least one treated pigment in particulate form with paper, board or card, for example by coating, spraying, dipping or soaking.

One preferred embodiment of the present invention comprises adding at least one treated pigment in particulate form to a paper precursor, for example to paper stock.

Paper stock may comprise for example from 2% to 10% by weight of preferably bleached pulp and from 90% to 98% by weight of water and preferably no further auxiliaries.

Treated pigment may be added to paper stock, for example in amounts from 0.001% to 1% by weight, based on total paper stock, and then the paper stock processed into paper in a conventional manner.

When, for example, wood or woody substrates are to be colored, this can be done at atmospheric pressure, at elevated pressure, for example in the range from 1.1 to bar and preferably up to 10 bar, or at reduced pressure, for example in the range from 50 to 800 mbar and preferably in the range from 100 to 650 mbar, or at combinations of various pressure conditions. Examples of suitable atmospheric pressure processes are dipping and soaking processes such as for example the open tank suction process, the open tank pressing-sucking process, open tank soaking, the hot and cold soaking process and the insertion process whereby poles are inserted into buckets butt end first and cold steeped. Examples of processes at elevated pressure are the closed tank pressure process. Examples of processes at reduced pressure are the vacuum process, the double vacuum process and the Boucherie process, Examples of processes employing combinations of various pressure conditions are the alternating pressure process, the Rueping process and the closed tank pressing-sucking process. To employ combinations of elevated pressure and reduced pressure, oscillating conditions may be employed, herein to be understood as meaning repeated pressure changes of reduced pressure in the aforementioned ranges to elevated pressure in the aforementioned ranges. The number of pressure changes is in itself not critical in that, for example, the pressure conditions can be changed from two times up to 500 times.

A suitable temperature for carrying out the present invention's process for coloring wood is for example in the range from 10 to 20° C. and preferably room temperature.

In one embodiment of the present invention, about 0.1 to 50 kg of treated pigment and preferably up to 30 kg of treated pigment are applied per m³ of wood. This embodiment is preferred when pressurized processes are to be employed for example.

One embodiment of the present invention comprises applying 0.01 to 20 g of treated pigment per m² of wood surface. This embodiment is preferred when dipping processes are to be employed for example.

One embodiment of the present invention comprises applying treated pigment in particulate form that is at least partially enveloped by at least one cationic copolymer together with one or more wood preservatives. Useful wood preservatives are disclosed in EP-A 0 316 602 for example. From 200 to 600 g of wood preservative per m² of wood surface can be applied superficially in the form of a dipping process for example. Processes employing pressure, such as the vacuum pressure process, may utilize for example from 1500 to 7000 kg of wood preservative per m³ of wood.

The contacting time duration may be for example in the range from 10 seconds to 48 hours and preferably in the range from 20 seconds to 24 hours.

The present invention further provides colored cellulosic substrates obtainable by the process of the present invention. They are notable for particular brightness of color, low tendency to bleed out and also, in the case of wood colored according to the present invention, for good light fastness and weathering resistance.

The present invention further provides treated pigments in particulate form prepared by
a) dispersing at least one pigment in particulate form with at least one nonionic surface-active material,
b) mixing the thus obtainable dispersion of pigment in particulate form and nonionic surface-active material with aqueous medium,
c) addition polymerizing at least one first monomer or addition copolymerization of a first mixture of comonomers in the presence of a mixture according to b) to form water-insoluble polymer or copolymer on the surface of pigment in particulate form,
d) adding at least one second monomer or a second mixture of comonomers and addition polymerization or copolymerization,
   wherein copolymer or polymer from steps c) and d) is met cationic.

Treated pigments according to the present invention are produced as described above.

The present invention further provides a process for preparing treated pigments according to the present invention, which comprises
a) dispersing at least one pigment in particulate form with at least one nonionic surface-active material,
b) mixing the thus obtainable dispersion of pigment in particulate form and nonionic surface-active material with aqueous medium,
c) addition polymerizing at least one first monomer or addition copolymerization of a first mixture of comonomers in the presence of a mixture according to b) to form water-insoluble polymer or copolymer on the surface of pigment in particulate form,
d) adding at least one second monomer or a second mixture of comonomers and addition polymerization or copolymerization,
   wherein copolymer or polymer from steps c) and d) is net cationic.

The invention is illustrated by working examples.

### General Preliminary Remarks:

n-C₁₈H₃₇—(OCH₂CH₂)₂₅—OH is ethoxylated n-octadecanol, prepared by following the following prescription:

242 g of n-octadecanol and 0.1 mol of KOH chips were dewatered in an autoclave at 100° C. and a pressure of 1 mbar in the course of 2 hours, then depressurized with nitrogen and purged 3 times with nitrogen and then heated to 130° C. in the autoclave. On 130° C. having been reached, the continuous addition commenced of 1100 g of ethylene oxide and continued for 3 h 20 min, at a pressure of up to 6.1 bar. On completion of the addition the reaction was allowed to continue until constant pressure was reached. This was followed by cooling down to 100° C. and degassing in the autoclave at 1 mbar for 60 min before the reaction product was removed at 70°. The yield was 1337 g.

The glass transition temperature was determined using a Mettler-Toledo TA8200 series DSC822 differential scanning calorimeter with a TSO 801RO sample robot. The differential scanning calorimeter was equipped with an FSR5 temperature sensor. The procedure used was in accordance with German standard specification DIN 53765.

### I. Treatment of Pigment in Particulate Form

I a) Dispersing of Pigment with Nonionic Surface-Active Material
I. 1a) Dispersing a Blue Pigment with a Nonionic Surface-Active Material

A Drais DCP SF 12 Superflow stirred ball mill was used to grind together:

### 1800 g of Pigment Blue 15:3

450 g of n-C₁₈H₃₇O(CH₂CH₂O)₂₅H
24 g of glutardialdehyde
30 g of tetramethylolacetylenediurea
3696 g of distilled water

Grinding was continued until the pigment particles had an average diameter of 130 nm.

Dispersion I. 1a) of pigment particles and nonionic surface-active material was obtained.

I. 2a) Dispersing a Yellow Pigment with a Nonionic Surface-Active Material

A Drais DCP SF 12 Superflow stirred ball mill was used to grind together:

### 1800 g of Pigment Yellow 138

450 g of n-C₁₈H₃₇O(CH₂CH₂O)₂₅H
24 g of glutardialdehyde
30 g of tetramethylolacetylenediurea
3696 g of distilled water

Grinding was continued until the pigment particles had an average diameter of 130 nm.

Dispersion I. 2a) of pigment particles and nonionic surface-active material was obtained.

I. 3a) Dispersing a Black Pigment with a Nonionic Surface-Active Material

A Drais DCP SF 12 Superflow stirred ball mill was used to grind together:

### Black Pigment

### 1800 g of Pigment Black 7

450 g of n-C₁₈H₃₇O(CH₂CH₂O)₂₅H
3696 g of distilled water

Grinding was continued until the pigment particles had a number-average diameter of 150 nm. Dispersion I. 3a) of pigment particles and nonionic surface-active material was obtained.

I b) Mixing with Water
I. 1b) Mixing of I. 1a) with Water

213.3 g of the dispersion of I. 1a) were mixed with 262.2 g of completely ion-free water by stirring in a 1 l tank equipped with stirrer, nitrogen feed and three metering means. 5.8 g of a 40% by weight aqueous solution of ethoxylated (5 ethylene oxide units per molecule on average) methyl-quaternized oleylammonium sulfate and 32 g of styrene were added and a pH of 4 was set with formic acid.

This gave a mixture I. 1b) of pigment in particulate form in an aqueous medium.

I. 2b) Mixing of I. 2a) with Water

213.3 g of the dispersion of I. 2a) were mixed with 262.2 g of completely ion-free water by stirring in a 1 l tank equipped with stirrer, nitrogen feed and three metering means. 5.8 g of a 40% by weight aqueous solution of ethoxylated (5 ethylene oxide units per molecule on average) methyl-quaternized oleylammonium sulfate and 32 g of styrene were added and a pH of 3.1 was set with formic acid.

This gave a mixture I. 2b) of pigment in particulate form in an aqueous medium.

I. 3b) Mixing of I. 3a) with Water

213.3 g of the dispersion of I. 3a) were mixed with 262.2 g of completely ion-free water by stirring in a 1 l tank equipped with stirrer, nitrogen feed and three metering means. 5.8 g of a 40% by weight aqueous solution of ethoxylated (5 ethylene oxide units per molecule on average) methyl-quaternized oleylammonium sulfate and 32 g of styrene were added and a pH of 4 was set with formic acid.

This gave a mixture I. 3b) of pigment in particulate form in an aqueous medium.

### I c) Polymerization

### I. 1c) Polymerization of I. 1b)

Nitrogen was passed through the mixture from step I. 1b) for 1 hour. The dispersion was then heated to 85° C. Thereafter, 1.6 g of tert-butyl hydroperoxide (10% by weight in water) and 1.6 g of HOCH₂SO₂Na were added.

The formation of a water-insoluble polymer on the blue pigment in particulate form was observed.

### I. 2c) Polymerization of I. 2b)

Nitrogen was passed through the mixture from step I. 2b) for 1 hour. The dispersion was then heated to 85° C. Thereafter, 1.6 g of tert-butyl hydroperoxide (10% by weight in water) and 1.6 g of HOCH₂SO₂Na were added.

The formation of a water-insoluble polymer on the yellow pigment in particulate form was observed.

### I. 3c) Polymerization of I. 3b)

Nitrogen was passed through the mixture from step I. 3b) for 1 hour. The dispersion was then heated to 85° C. Thereafter, 1.6 g of tert-butyl hydroperoxide (10% by weight in water) and 1.6 g of HOCH₂SO₂Na were added.

The formation of a water-insoluble polymer on the black pigment in particulate form was observed.

### I d) Adding an Emulsion of Comonomers and Further Copolymerization

### I. 1d) Adding an Emulsion of Comonomers and Further Copolymerization to I. 1c)

15 minutes after the addition of tert-butyl hydroperoxide and HOCH₂ SO₂Na as per step I. 1c) a mixture of the following composition was added over a period of 90 minutes:

224 g of completely ion-free water
12 g of aqueous solution of ethoxylated (5 ethylene oxide units per molecule on average) methyl-quaternized oleylammonium sulfate (40% by weight)
3.2 g of acrylic acid
14.4 g of dimethylaminopropylmethacrylamide
24 g of n-butyl acrylate
44.8 g of ethyl acrylate
73.6 g of methyl methacrylate

At the same time, the addition was commenced of a solution of 3.2 g of 2,2′-azobis(2-amidinopropane) dihydrochloride in 133.3 g of water, and continued over a period of 105 minutes. The temperature was maintained at 85° C. during the addition.

On completion of the addition, stirring was continued at 85° C. for 30 minutes and then, for deodorization, the concurrent addition was commenced of a solution of 5.5 g of tert-butyl hydroperoxide (70% in water) in 18 g of completely ion-free water and a solution of 3.5 g of HOCH₂SO₂Na in 20 g of completely ion-free water and continued for a period of 90 minutes.

Thereafter, the batch was cooled down to room temperature.

The aqueous dispersion thus obtained was subsequently filtered through a 125 μm net to obtain dispersion D.1.1. The solids content of dispersion D.1.1 was 25%. The particle diameter distribution was determined in accordance with ISO 13321 using an Autosizer IIC from Malvern and was found to possess maxima at 133 and 120 nm. The glass transition temperature T_{g} was found to be 17° C.

### I. 2d) Adding an Emulsion of Comonomers and Further Copolymerization to I. 2c)

15 minutes after the addition of tert-butyl hydroperoxide and HOCH₂SO₂Na as per step I. 2c) a mixture of the following composition was added over a period of 90 minutes:

224 g of completely ion-free water
12 g of aqueous solution of ethoxylated (5 ethylene oxide units per molecule on average) methyl-quaternized oleylammonium sulfate (40% by weight)
3.2 g of acrylic acid
14.4 g of dimethylaminopropylmethacrylamide
24 g of n-butyl acrylate
44.8 g of ethyl acrylate
73.6 g of methyl methacrylate

At the same time, the addition was commenced of a solution of 3.2 g of 2,2′-azobis(2-amidinopropane) dihydrochloride in 133.3 g of water, and continued over a period of 105 minutes. The temperature was maintained at 85° C. during the addition.

On completion of the addition, stirring was continued at 85° C. for 30 minutes and then for deodorization, the concurrent addition was commenced of a solution of 5.5 g of tert-butyl hydroperoxide (70% by weight in water) in 18 g of completely ion-free water and a solution of 3.5 g of HOCH₂SO₂Na in 20 g of completely ion-free water and continued for a period of 90 minutes.

Thereafter, the batch was cooled down to room temperature.

The aqueous dispersion thus obtained was subsequently filtered through a 125 μm net to obtain dispersion D.2.1. The solids content of dispersion D.2.1 was 25.6%. The particle diameter distribution was determined in accordance with ISO 13321 using an Autosizer IIC from Malvern and was found to possess maxima at 147 and 128 nm. The glass transition temperature was found to be 17° C.

### I. 3d) Adding an Emulsion of Comonomers and Further Copolymerization to I. 3c)

15 minutes after the addition of tert-butyl hydroperoxide and HOCH₂SO₂Na as per step I. 3c) a mixture of the following composition was added over a period of 90 minutes:

224 g of completely ion-free water
12 g of aqueous solution of ethoxylated (5 ethylene oxide units per molecule on average) methyl-quaternized oleylammonium sulfate (40% by weight)
3.2 g of acrylic acid
14.4 g of dimethylaminopropylmethacrylamide
24 g of n-butyl acrylate
44.8 g of ethyl acrylate
73.6 g of methyl methacrylate

At the same time, the addition was commenced of a solution of 3.2 g of 2,2′-azobis(2-amidinopropane) dihydrochloride in 133.3 g of water, and continued over a period of 105 minutes. The temperature was maintained at 85° C. during the addition.

On completion of the addition, stirring was continued at 85° C. for 30 minutes and then, for deodorization, the concurrent addition was commenced of a solution of 5.5 g of tert-butyl hydroperoxide (70% by weight in water) in 18 g of completely ion-free water and a solution of 3.5 g of HOCH₂SO₂Na in 20 g of completely ion-free water and continued for a period of 90 minutes.

Thereafter, the batch was cooled down to room temperature.

The aqueous dispersion thus obtained was subsequently filtered through a 125 μm net to obtain dispersion D.3.1. The solids content of dispersion D.3.1 was 25.6%. The particle diameter distribution was determined in accordance with ISO 13321 using an Autosizer IIC from Malvern and was found to possess maxima at 143 and 382 nm. The glass transition temperature was found to be 13° C.

### II. Production of Colored Wood

### II.1 Production of a Formulation

A formulation was produced by mixing the following together in a vessel:

50 g of n-dodecyldimethylamine
10 g of 2-ethylhexanoic acid
15 g of phosphonic acid
25 g of propylene glycol

Formulation F-1 was obtained.

### II.2 Production of Soaking Solutions

### II.2.1 Production of a Blue Soaking Solution

An aqueous soaking solution T-1 was produced by mixing 30 l of water with 303 g of dispersion D1.1 and 303 g of F-1.

### II.2.2 Production of a Yellow Soaking Solution

An aqueous soaking solution T-2 was produced by mixing 30 l of water with 303 g of dispersion D.2.1 and 303 g of F-1.

### II.2.3 Production of a Black Soaking Solution

An aqueous soaking solution T-3 was produced by mixing 30 l of water with 303 g of dispersion D.3.1 and 303 g of F-1.

### II.2.4 Production of Comparative Soaking Solutions

A Drais Superflow DCP SF 12 stirred ball mill was used to mix together

### 500 g of Pigment Green 36

200 g of a 90% by weight solution of ethoxylated isotridecanol comprising on average 10 equivalents of ethylene oxide
100 g of propylene glycol
200 g of water.
90 g of the pigment dispersion thus obtainable were mixed with 303 g of F-1 and 30 l of water to obtain comparative soaking solution V-T-4.

### II.3 Coloration of Pine Wood, General Prescription Illustrated Using a Blue Coloration as Example

0.02 m³ of wood (pine, slat shaped, planed down, length/width/thickness 50 cm/20 cm/3 cm) was soaked with 30 l of soaking solution T-1 in a closed tank pressure process at room temperature according to the following parameters:

one hour prevacuum (200 mbar),
two hours pressure (8 bar).

This was followed by depressurizing, rinsing with water and drying at room temperature for two days to obtain colored wood H-T-1 according to the present invention.

Tests were carried out as to compatibility with the wood preservative solution, the staining of the wood, the penetration of the soaking solution into the wood, the behavior of the coloration when dyes were already present, stability of the soaking solution in the course of coloration (impregnation), and the decrease in the stain in the course of weathering. The results are summarized in table 1.

Stain reduction due to weathering was tested by storing colored wood according to the present invention and comparative wood outdoors at an angle of 45°, facing southwest, for one summer month (July).

Further experiments were carried out in similar fashion, except that soaking solution T-1 was replaced by T-2, T-3 and V-T-4 respectively to obtain colored wood H-T-2 (yellow) according to the present invention, colored wood H-T-3 (black) according to the present invention and comparative wood V-H-T-4 respectively.

TABLE 1
Results of coloration experiments (with notes on visual impression)

| | H-T-1 | V-H-T-4 |
|---|---|---|
| Compatibility, storage | 5 (virtually no | 4 (slight sedimentation |
| stability [score] | sedimentation of | of pigment particles) |
| | pigment particles) | |
| Wood stain [score] | 5 (uniformly hiding) | 3 (slightly cloudy, not |
| | | uniformly hiding) |
| Penetration behavior | 4 (visible) | 2 (pigment on top |
| [score] | | and blocking pores) |
| Stability in coloration | 4 (soaking solution | 3-4 (soaking solution |
| [score] | remains stable) | remains almost stable) |
| Stain reduction | 4 (good color cover) | 2 (nonuniform color cover, |
| under weathering | | wood peeks through gray |
| | | at less hiding spots) |

Scores: 5 (very good), 4 (good), 3 (adequate), 2 (poor), 1 (inadequate)

### III. Production of Colored Paper

Dyed paper was produced according to the following general prescription (using D.1.1 as example):

A mixture of 70% by weight of bleached pine sulfate pulp and 30% by weight of bleached birch sulfate pulp was beaten in a laboratory refiner to a freeness of 22° Schopper-Riegler to obtain a beaten pulp mixture having a solids content of 10.3% by weight, determined by oven drying.

48.5 g of beaten pulp mixture (corresponding to 5 g of solids) were suspended in a total of 250 ml of tap water in a glass beaker. 0.5 g of dispersion D.1.1 was added to the pulp suspension thus obtainable. After stirring for 5 minutes the suspension was diluted with tap water to a total of 3l. A sheet of paper was then produced on a Rapid-Köthen 150 g/m² sheet former. The sheet was pressed off and dried on a steel cylinder between two filter papers at 85° C. The dyeing obtained was visually inspected and evaluated under CIE-LAB. The filtrate was collected and visually inspected. Colored paper P1 according to the present invention was obtained.

Further experiments were carried out in similar fashion except that dispersion D.1.1 was replaced by D.2.1, D.3.1 and a comparative dispersion V-D4 respectively to obtain colored paper P2 (yellow) according to the present invention, colored paper P3 (black) according to the present invention and comparative paper V-P4 respectively.

The comparative paper coloring was carried out by replacing a treated pigment dispersion used according to the present invention with 0.05 g of a comparative dispersion V-D4 obtained as follows:

A Drais Superflow DCP SF 12 stirred ball mill was used to mix together

### 400 g of Pigment Blue 15:1

80 g of n-C₁₈H₃₇O(CH₂CH₂O)₂₅H
70 g of diethylene glycol
450 g of completely ion-free water

The above procedure was repeated, except that D.1.1 was replaced by comparative dispersion V-D4. It was observed that the filtrate had an intensive color in the comparative run despite the smaller amount of colorant. Higher amounts of colorant did not lead to an increased takeup of colorant.

TABLE 2
Evaluation of inventive papers and of dyeing efficiency

| | | | | Filtrate |
|---|---|---|---|---|
| Colorant | L | a* | b* | colored |
| P1 | 62.1 | −21.3 | 36.0 | slightly |
| P2 | 92.8 | −10.7 | 66.4 | slightly |
| P3 | 47.6 | 0.7 | 2.4 | slightly |
| V-P4 | 59.7 | −21.0 | −27.6 | very strongly |

The dyeings are notable for brightness, high bleed-out fastnesses and high light fastnesses.

Dispersions D.1.1, D.2.1 and D.3.1 are readily miscible with each other. It is thus possible for example to create intensive, bright greens by mixing yellow and blue. Dispersions D.1.1, D.2.1 and D.3.1 are stable at temperatures such as 4° C. and 50° C. for example for a period of 10 weeks for example.

1: A process for coloring cellulosic substrates, which comprises substrates to be colored, or precursors thereof, being contacted with at least one treated pigment in particulate form that is at least partially enveloped by at least one cationic copolymer.

2: The process according to claim 1, wherein cationic copolymers comprise copolymers constructed of at least one nonionic comonomer and at least one comonomer having at least one protonatable nitrogen atom per molecule.

3: The process according to claim 1, wherein substrates to be colored, or precursors thereof, are contacted with at least one treated pigment in particulate form that has been prepared according to a process comprising the steps of:
a) dispersing at least one pigment in particulate form with at least one nonionic surface-active material,
b) mixing the thus obtainable dispersion of pigment in particulate form and nonionic surface-active material with aqueous medium,
c) addition polymerizing at least one first monomer or addition copolymerization of a first mixture of comonomers in the presence of a mixture according to b) to form water-insoluble polymer or copolymer on the surface of pigment in particulate form,
d) adding at least one second monomer or a second mixture of comonomers and addition polymerization or copolymerization.

4: The process according to claim 1, wherein step d) produces a polymer or copolymer having a glass transition temperature T_{g} of −30° C. or higher.

5: The process according to claim 1, wherein pigments in particulate form are selected from carbon black, calcium carbonate, kaolin and organic pigments.

6: The process according to claim 1, wherein the first monomer in step c) comprises a vinylaromatic compound or a compound of the general formula I 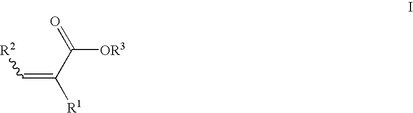
where
R¹ is selected from hydrogen, branched C₁-C₁₀-alkyl or unbranched C₁-C₁₀-alkyl,
R² is selected from hydrogen, branched C₁-C₁₀-alkyl or unbranched C₁-C₁₀-alkyl,
R³ is selected from branched C₄-C₁₀-alkyl or unbranched C₄-C₁₀-alkyl.

7: The process according to claim 1, wherein the first mixture of comonomers comprises a mixture of at least one vinylaromatic compound and at least one compound of the general formula I.

8: The process according to claim 1, wherein R¹ and R² are both hydrogen in one compound of the general formula I.

9: The process according to claim 1, wherein the second monomer added is a monomer of the general formula II 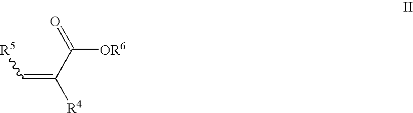
where
R⁴ is selected from hydrogen, branched C₁-C₁₀-alkyl or unbranched C₁-C₁₀-alkyl,
R⁵ is selected from hydrogen, branched C₁-C₁₀-alkyl or unbranched C₁-C₁₀-alkyl,
R⁶ is selected from branched C₁-C₁₀-alkyl or unbranched C1-C10-alkyl.

10: The process according to claim 1, wherein the second mixture of comonomers comprises at least one monomer of the general formula II.

11: The process according to claim 1, wherein R⁴ is hydrogen or methyl and R⁵ is hydrogen in one compound of the general formula II.

12: The process according to claim 1, wherein the second mixture of comonomers comprises at least one comonomer selected from vinylaromatic compound and a compound of the general formula I.

13: The process according to claim 1, wherein step d) comprises up to 20% by weight, based on the second mixture of comonomers, of at least one compound of the formula V a or V b 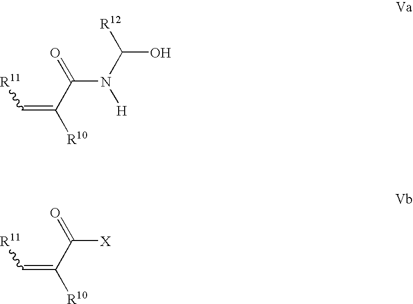
where
R¹⁰ to R¹² are the same or different and are each selected from hydrogen, branched C₁-C₁₀-alkyl and unbranched C₁-C₁₀-alkyl,
X is selected from hydrogen, glycidyl, protonatable groups having tertiary amino groups and enolizable groups having 1 to 20 carbon atoms.

14: The process according to claim 1, wherein cellulosic substrates comprise wood.

15: The process according to claim 1, wherein cellulosic substrates comprise woody or so-called wood-free paper and the paper precursor comprises paper stock.

16: Colored cellulosic substrates obtainable by a process according to claim 1.

17: Treated pigments in particulate form prepared by
a) dispersing at least one pigment in particulate form with at least one nonionic surface-active material,
b) mixing the thus obtainable dispersion of pigment in particulate form and nonionic surface-active material with aqueous medium,
c) addition polymerizing at least one first monomer or addition copolymerization of a first mixture of comonomers in the presence of a mixture according to b) to for water-insoluble polymer or copolymer on the surface of pigment in particulate form,
d) adding at least one second monomer or a second mixture of comonomers and addition polymerization or copolymerization,
wherein copolymer or polymer from steps c) and d) is cationic.

18: A process for preparing treated pigments according to claim 17, which comprises
a) dispersing at least one pigment in particulate for with at least one nonionic surface-active material,
b) mixing the thus obtainable dispersion of pigment in particulate form and nonionic surface-active material with aqueous medium,
c) addition polymerizing at least one first monomer or addition copolymerization of a first mixture of comonomers in the presence of a mixture according to b) to form water-insoluble polymer or copolymer on the surface of pigment in particulate form,
d) adding at least one second monomer or a second mixture of comonomers and addition polymerization or copolymer or copolymerization,
wherein copolymer or polymer from steps c) and d) is cationic.
